(19) United States
(12) Patent Application Publication
(10) Pub. No.: US 2017/0306633 A1
(43) Pub. Date: Oct. 26, 2017

(54) REINFORCED TILE

(71) Applicant: OCV Intellectual Capital, LLC, Toledo, OH (US)

(72) Inventor: David R. Hartman, Granville, OH (US)

(21) Appl. No.: 15/510,344

(22) PCT Filed: Oct. 6, 2015
(86) PCT No.: PCT/US15/54156

§ 371 Date: Jun. 29, 2017

(51) Int. Cl. E04F 15/08; E04F 15/02; B32B 9/04; B32B 9/00; E04F 13/08; E04F 15/22; E04F 13/14

(52) U.S. Cl. CPC E04F 15/085; E04F 15/225; E04F 15/0215; E04F 13/142; B32B 9/005; E04F 13/0862; B32B 9/047; B32B 2262/101

(57) ABSTRACT

Reinforced tiles, as well as systems and methods for reinforcing tiles, are provided. The reinforced tiles have enhanced durability, compressive strength, shear strength, and modulus of elasticity.

### RELATED APPLICATIONS

This application claims priority to and all benefit of U.S. Provisional Patent Application Ser. No. 62/061,194, filed on Oct. 8, 2014, for REINFORCED TILE, the entire disclosure of each of which is fully incorporated herein by reference.

### TECHNICAL FIELD

The present disclosure is directed to a reinforced tile and systems and methods of making and using the reinforced tile.

### BACKGROUND

Tiles are used in a variety of floor, wall, and exterior architectural applications. Traditionally, tiles used in flooring and exterior wall applications must be more durable than tiles used in interior wall applications. Floor tiles must typically be large enough to dissipate the compressibility forces caused by walking on the tile or caused by environmental factors. Smaller tiles are generally not suitable for such applications because they lack sufficient strength. However, larger tiles are more expensive and more difficult to produce. Thus, there remains a need for smaller, less expensive, and easier to produce tiles having enhanced durability that may be used in applications requiring higher compressibility strength.

### SUMMARY

It has been found that the embodiments of the reinforced tiles, according to the present disclosure, have improved durability, as well as enhanced compressive strength, shear strength, and modulus of elasticity.

In one embodiment, a reinforced tile is provided. The reinforced tile comprises a tile, having a thickness of 10 millimeters or less, and an elastic composite member including reinforcing fibers.

In one embodiment, a method for making a reinforced tile is provided. The method comprises providing a tile having a thickness of 10 millimeters or less, disposing an elastic composite member on at least one surface of the tile, and curing the reinforced tile.

In one embodiment, a method for making a reinforced tile comprising resin infusion molding is provided.

In one embodiment, a method for making a reinforced tile comprising curing and consolidation is provided.

Additional features and advantages will be set forth in part in the description that follows, and in part may be apparent from the description, or may be learned by practice of the embodiments disclosed herein. The objects and advantages of the embodiments disclosed herein will be realized and attained by means of the elements and combinations particularly pointed out in the appended claims. It is to be understood that both the foregoing summary and the following detailed description are examples and are explanatory only and are not restrictive of the disclosure herein or as otherwise claimed.

### DESCRIPTION OF THE DRAWINGS

Embodiments of the disclosure will be apparent from the more particular description of certain example embodiments provided below and as illustrated in the accompanying drawings.

FIG. 1 is a side view of a reinforced tile having an elastic composite member disposed thereon;

FIG. 2 is a side view of a reinforced tile having an elastic composite member disposed thereon and having a scrim; and

FIG. 3 is a top view of a reinforced tile having an elastic composite member disposed thereon and having a scrim.

### DETAILED DESCRIPTION

Described herein are systems and methods for providing a composite tile having increased durability. The reinforced tile has enhanced compressive strength, shear strength, and modulus of elasticity. As a result, thinner tiles are rendered suitable for applications that would typically require thicker tiles.

Compared to conventional tiles, which require larger sizes and thicknesses to be suitable for higher impact applications, use of a reinforcing member allows the inventive tiles disclosed herein to be smaller and thinner than tiles conventionally used for such applications. Typically, tiles used for flooring or exterior applications are between 8-10 millimeters or larger in thickness. Tiles used in interior wall applications can be smaller, such as 3-5 millimeters in thickness.

Tiles used in flooring applications must have sufficient strength and elasticity to withstand the force of impact from walking on the tiles. However, these larger tiles must be batch fired or hot pressed in order to produce a sufficiently strong tile. Extrusion of tiles is less costly and more efficient than batch firing or hot pressing but generally produces a smaller, weaker tile. The embodiments of the reinforced tile disclosed herein exceed necessary impact criteria while being smaller and lighter than conventional tiles meeting these impact requirements. For example, a thin tile previously only suitable for interior wall applications can be rendered suitable for flooring and exterior wall applications through use of a reinforcing member.

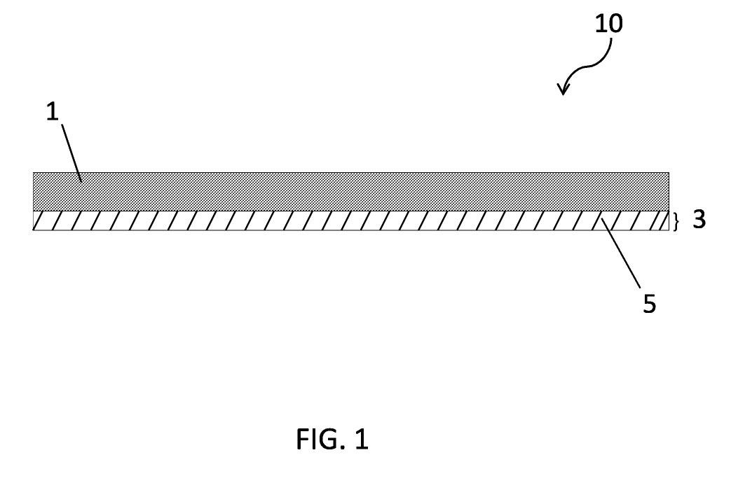

Referring now to FIG. 1, embodiments of the present disclosure provide a reinforced tile 10 for use in floor, interior wall, and exterior wall surface applications. The reinforced tile 10 comprises a tile 1 and an elastic composite member 3 which includes reinforcing fibers 5. The elastic composite member 3 may be a membrane, such as a tensile membrane, or a backing, such as a film, or any other material that deforms elastically or non-permanently upon the application of force.

In certain embodiments, the tile 1 of the reinforced tile 10 may have a thickness of 10 millimeters or less. In other embodiments, the tile 1 may have a thickness of between 8 millimeters and 10 millimeters. In other embodiments, the tile 1 may have a thickness of between 3 millimeters and 8 millimeters. In other embodiments, the tile 1 may have a thickness of between 3 millimeters and 5 millimeters. In other embodiments, the tile 1 may have a thickness of less than 5 millimeters. In other embodiments, the tile 1 may have a thickness of approximately 8 millimeters. In other embodiments, the tile 1 may have a thickness of approximately 7 millimeters. In other embodiments, the tile 1 may have a thickness of approximately 6 millimeters. In other embodiments, the tile 1 may have a thickness of approximately 5 millimeters. In other embodiments, the tile 1 may have a thickness of approximately 4 millimeters. In other embodiments, the tile 1 may have a thickness of approximately 3 millimeters.

In some embodiments, the ratio of a thickness of the elastic composite member 3 to the thickness of the tile 1 ranges from 1:1 to 1:17. In other embodiments, the ratio of a thickness of the elastic composite member 3 to the thickness of the tile 1 is 1:10.

Embodiments of the reinforced tile 10 disclosed herein possess sufficient strength and compression to absorb and disperse the impact of normal use and movement and to withstand localized failure across a range of applications. As such, tiles previously unsuitable for use in such applications, due to insufficient size or strength, are rendered suitable by use of a reinforcing backing. Typically, the bending stress along the back surface of a tile and the displacement of the tile from impact on the tile causes failure in tension on the back surface which can result in the tile cracking or otherwise becoming unusable. Reinforcing the tile with a member having significant strength and a similar or higher modulus of elasticity than the tile itself increases tolerability of the tile to transverse shear stress and compressive stress to prevent failure of the tile.

To be suitable for such use, in certain embodiments of the reinforced tile 10, the elastic composite member 3 may have a modulus of elasticity less than or equal to 50 GPa. In other embodiments, the modulus of elasticity of the elastic composite member 3 may be between 2 GPa and 50 GPa. In other embodiments, the modulus of elasticity of the elastic composite member 3 may be between 10 GPa and 30 GPa. In other embodiments, the modulus of elasticity of the elastic composite member 3 may be between 20 GPa and 25 GPa. In certain embodiments, the elastic composite member may have a flex shear strength of at least 50 MPa and a compression shear strength of at least 600 MPa. In certain embodiments, the elastic composite member 3 may have a flex shear strength of between 50 MPa and 90 MPa and a compression shear strength of between 600 MPa and 900 MPa. In certain embodiments, the ratio of the flex shear strength to the compression shear strength of the elastic composite member ranges between 1:10 and 1:12.

The elastic composite member 3 may be affixed to or otherwise interfaced with the tile 1 in any suitable manner. In certain embodiments, the elastic composite member 3 is affixed to the tile 1 using a first adhesive. In other embodiments, the elastic composite member 3 is impregnated with the first adhesive. In some embodiments, the first adhesive is a resin selected from the group consisting of an epoxy, polyurethane, cement, an acrylic, a thermoplastic, or combinations thereof. In certain embodiments, the tile 1 is fully formed prior to affixing the reinforcing elastic composite member 3.

In certain embodiments the tile 1 is ceramic. As used herein, the term “ceramic tile” is intended to mean any tile made of earthenware, stoneware, porcelain, bone china, oxides, non-oxides, and combinations thereof such as fired clay, brick, concrete, marble, travertine, quarry tile, terracotta, and may be particulate reinforced or fiber reinforced. Ceramic tiles may also be composites of any of the above-mentioned materials. In certain embodiments, the tile 1 is ceramic and may be glazed or unglazed.

The reinforced tile 10 may have an aesthetically pleasing or otherwise ornamental upper surface formed from various materials including any of the above-mentioned materials in addition to elastomers such as natural or synthetic rubber, polymers such as plastic cement, polyvinyl chloride (PVC), polyethylene (PE), polypropylene (PP), polyurethane (PU) composite, glass-based materials and facings, natural materials such as granite, and plant-based materials such as wood, bamboo, or cork.

In certain embodiments, the reinforced tile 10 is reinforced using glass reinforcing fibers 5. In certain embodiments, the glass fibers may be selected from the group consisting of E-glass, H-glass, R-glass, S-glass, EC-R glass, and combinations thereof. In some embodiments, the glass fibers are discrete fibers. For example, the glass fibers may be chopped fibers. The chopped fibers may have a length between 1/64 inches and 4 inches. In other embodiments, the chopped fibers may have a length between ¼ inches and 2 inches. In other embodiments, the chopped fibers may have a length of at least 1/64 inches. In other embodiments, the chopped fibers may have a length of less than or equal to 4 inches. In some embodiments, the glass fibers are continuous fibers. In all such embodiments, the fibers are typically sized appropriately for the matrix and intended application.

In certain embodiments, the reinforced tile 10 is reinforced using carbon reinforcing fibers 5. In certain embodiments, the reinforced tile 10 is reinforced using both glass and carbon reinforcing fibers 5. In certain embodiments, the reinforced tile 10 is reinforced using either glass or carbon reinforcing fibers 5 in combination with any other suitable reinforcing material known in the art.

The elastic composite member 3 may be formed of any materials compatible with currently used tiles and tile systems. In certain embodiments, the elastic composite member 3 comprises a thermoplastic matrix supporting the reinforcing fibers 5. The thermoplastic matrix can include poly(methyl methacrylate), polyamides, polybenzimidazole, polyethene, polypropylene, polystyrene, PVC, polytetrafluoroethylene, may be a thermoplastic elastomeric material, or may be a combination or blend thereof, such as a blend of polycarbonate and acrylonitrile-butadiene-styrene (ABS). In certain embodiments, the elastic composite member 3 comprises a thermoset matrix. The thermoset matrix can include acrylics, bioesters, and urethanes. In certain embodiments, the elastic composite member 3 comprises a blend of thermoplastic materials and thermoset materials. In certain embodiments, the elastic composite member 3 comprises 62% by weight of the reinforcing fibers 5 and 38% by weight of the resin system.

In certain embodiments, the elastic composite member 3 may comprise a plurality of reinforcing fibers 5. A first portion of the reinforcing fibers 5 may be disposed in a first direction and a second portion of the reinforcing fibers 5 may be disposed in a second direction. In certain embodiments, a first portion of the reinforcing fibers 5 may be disposed in a first direction and a second portion of the reinforcing fibers 5 may be disposed in a second direction wherein the first and second directions are oriented at an angle of 0-90° to one another. Alternatively, a first portion of the reinforcing fibers 5 may be disposed in a first direction oriented at 45° and a second portion of the reinforcing fibers 5 may be may be disposed in a second direction oriented at −45° relative to the first direction.

In certain embodiments, the elastic composite member 3 is a fabric. The fabric may be woven or non-woven. The fabric may comprise a closed or tight weave or may comprise an open or loose weave or scrim. The choice of weave is based on the choice of structural under-surface or subflooring. For example, a more open or looser weave may be used in conjunction with a stiffer undersurface or subfloor, such as cement. Whereas, a more closed or tighter weave may be used in conjunction with an undersurface or subfloor having less strength or greater compressibility and more pronounced shock waves, such as wood.

In certain embodiments, the elastic composite member 3 is a fiberglass mat. The fiberglass mat may be woven or non-woven. The fiberglass mat may comprise a plurality of plies. In certain embodiments, the fiberglass mat includes 1-5 plies each having a weight of 50 g/m² to 800 g/m².

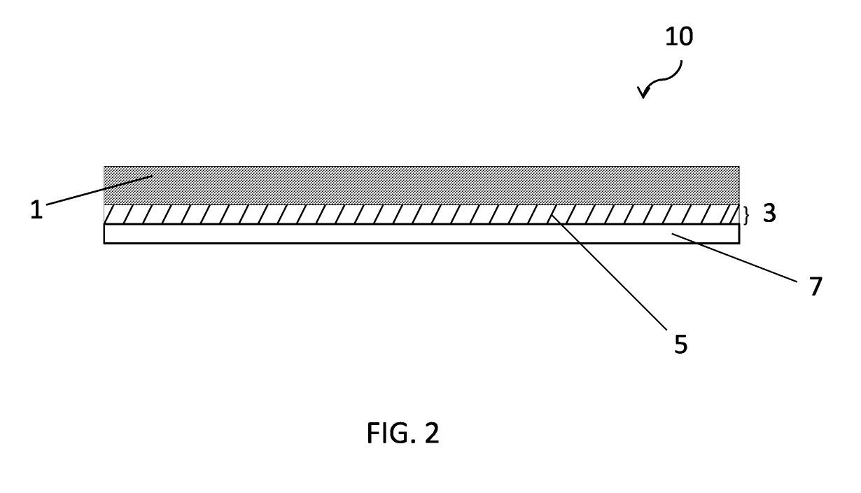

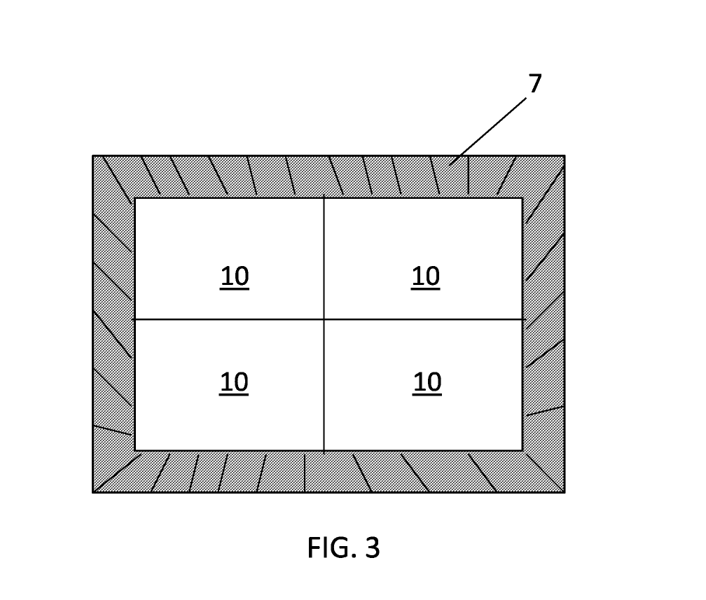

For ease of transportation and installation, certain embodiments of the reinforced tile 10 may comprise a scrim 7 as shown in FIGS. 2 and 3. The scrim 7 may be disposed between the tile 1 and the elastic composite member 3. Alternatively, the scrim 7 may be disposed on the elastic composite member 3 opposite the tile 1. The scrim 7 may be disposed on a plurality of reinforced tiles 10 such that the reinforced tiles 10 may be transported and installed as a unit (FIG. 3). While the scrim 7 may add negligible strength to the reinforced tile 10, the scrim 7 alone does not provide sufficient strength to the tile 1 such that the elastic composite member 3 may be eliminated.

The reinforced tile 10 may be affixed to or otherwise mounted on a structural surface by any suitable method known in the art. In certain embodiments, the reinforced tile 10 may be affixed to the structural surface using a second adhesive. In some embodiments, the second adhesive is disposed on the elastic composite member 3. In some embodiments, the elastic composite member 3 is impregnated with the second adhesive. In some embodiments, the second adhesive is a resin selected from the group consisting of an epoxy, polyurethane, cement, an acrylic, a thermoplastic, or combinations thereof. In some embodiments, the reinforced tile 10 is affixed to a structural surface using mechanical fasteners such as brackets, nails, screws, or clamps. In some embodiments, the reinforced tile 10 is not affixed to a structural surface but is instead held in place over the structural surface by other means, such as in a floating floor.

The structural surface may be a floor, subfloor, wall (e.g., interior wall), or building exterior or framework, all of which may be made of any suitable material such as wood, drywall, cement, concrete, brick, stucco, aluminum, or steel.

In certain embodiments, the building exterior is a ventilated façade having air space for ventilation between a steel or aluminum building or mounting structure and the reinforced tile 10. In embodiments including a ventilated façade, the reinforced tile 10 may be mechanically affixed to the steel or aluminum building or mounting structure using fasteners such as brackets, nails, screws, or clamps. Such mechanical attachment of reinforced tile 10 to the steel or aluminum building or mounting structure requires the elastic composite member 3 to have the above-noted flex shear strength and compression shear strength in order to withstand failure. Additionally, the elastic composite member 3 strengthens the reinforced tile 10 at points of weakness such as the point at which the reinforced tile 10 is mechanically attached to the building or mounting structure. Further, the elastic composite member 3 strengthens the reinforced tile 10 such that the reinforced tile 10 is resistant to frost and resistant to cracking resulting from exposure to freezing temperatures.

In one embodiment, the reinforced tile 10 is affixed to the building structure using anchor brackets such that anchors are inserted into the reinforced tile 10 and coupled to brackets disposed on the building structure. In certain embodiments, the anchors are pre-installed on the reinforced tile 10. In other embodiments, the reinforced tile 10 is pre-drilled for easy insertion of the anchors at the installation site.

The various embodiments of the tile 1 and the elastic composite member 3 disclosed herein, as well as other contemplated embodiments, may be manufactured by any process or suitable method (now known or known in the future). Many such techniques are known and can easily be applied by one of ordinary skill in the art to the various embodiments presented herein. Example processes include, but are not limited to, resin injection or infusion molding, curing and consolidation, and continuous lamination of the tile system. In one example of continuous lamination of the tile system, the tile 1 is formed and cured during upstream processing and allowed to begin cooling; as the tile 1 moves downstream and continues cooling, the elastic composite member 3 is disposed thereon and cured by the residual heat dissipating from the cured tile 1. Example elastic composite members 3 used in such processes include pre-pregs, pre-forms, and polycarbonate fabrics or films.

In another embodiment, methods of making any of the embodiments of the reinforced tile 10 disclosed or otherwise suggested herein are provided. The method comprises providing a tile 1 having a thickness of 10 millimeters or less, disposing an elastic composite member 3 on at least one surface of the tile, and curing the reinforced tile.

The tile 1 may be produced by any means known in the art. In some embodiments, the tile 1 is extruded. In some embodiments, the tile 1 is hot pressed. The tile 1 may have a decorative surface and a non-decorative surface. The tile 1 may comprise a glazed surface and an unglazed surface or may be entirely unglazed. The tile 1 may be fully formed prior to the elastic composite member 3 being disposed thereon. Alternatively, formation of the tile 1 may be concluded after the elastic composite member 3 has been disposed thereon. For example, the tile 1 itself may be cured after disposing the elastic composite member 3 thereon or simultaneously with curing of the elastic composite member 3 or simultaneously with curing of the reinforced tile 10 (i.e., the tile and the elastic composite member together). An example includes allowing the residual heat from a cured tile 1 that is cooling to cure the elastic composite member 3. Curing of the reinforced tile 10 may comprise in-line firing of the reinforced tile 10.

In certain embodiments, the elastic composite member 3 has a modulus of elasticity of less than or equal to 20 GPa. In certain embodiments, the elastic composite member 3 includes reinforcing fibers 5 as discussed above.

Although the present invention has been described with reference to particular means, materials, and embodiments, from the foregoing description, one skilled in the art can easily ascertain the essential characteristics of the present disclosure, and various changes and modifications can be made to adapt the various uses and characteristics without departing from the spirit and scope of the present invention as described above and set forth in the attached claims.

All ranges and parameters, including but not limited to percentages, parts, and ratios, disclosed herein are understood to encompass any and all sub-ranges assumed and subsumed therein and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

In some embodiments, it may be possible to utilize the various inventive concepts in combination with one another (e.g., one or more of the first, second, third, etc., embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Thus, in general, all individual embodiments and features thereof, as disclosed or suggested herein, may be combined in any manner consistent with the general inventive concepts. Accordingly, the systems, methods, and tiles may comprise, consist of, or consist essentially of the essential elements disclosed or suggested, as well as any additional or optional element disclosed or suggested herein or otherwise useful in such applications.

1. A reinforced tile comprising:
a tile made of ceramic or porcelain; and
an elastic composite member including reinforcing fibers, characterized in that:
the tile has a thickness of 10 millimeters or less,
the elastic composite member has a flex shear strength of between 50 MPa and 90 MPa, and
the elastic composite member has a modulus of elasticity of between 2 GPa and 50 GPa.

2. The reinforced tile of claim 1, wherein the elastic composite member is affixed to the tile using an adhesive.

3. The reinforced tile of claim 1, wherein the thickness of the tile is between 3 millimeters and 8 millimeters.

4-5. (canceled)

6. The reinforced tile of claim 1, wherein the ratio of a thickness of the elastic composite member to the thickness of the tile is between 1:1 and 1:17.

7. The reinforced tile of claim 1, wherein the reinforcing fibers are glass fibers.

8. The reinforced tile of claim 7, wherein the glass fibers are selected from the group consisting of E-glass, H-glass, R-glass, S-glass, E-CR glass, and combinations thereof

9. The reinforced tile of claim 7, wherein the glass fibers are chopped fibers.

10. The reinforced tile of claim 7, wherein the glass fibers are continuous fibers.

11-12. (canceled)

13. The reinforced tile of claim 1, wherein the elastic composite member comprises a thermoplastic.

14. The reinforced tile of claim 1, wherein the elastic composite member comprises a plurality of reinforcing fibers, wherein a first portion of the reinforcing fibers are disposed in a first direction and a second portion of the reinforcing fibers are disposed in a second direction.

15. The reinforced tile of claim 1, wherein the elastic composite member is a fiberglass mat.

16. The reinforced tile of claim 15, wherein the fiberglass mat comprises a plurality of plies.

17. The reinforced tile of claim 16, wherein a weight of each of the plies in the fiberglass mat is between 50 g/m² and 800 g/m².

18-20. (canceled)

21. The reinforced tile of claim 1, wherein a scrim connects the reinforced tile to a plurality of other similarly constructed reinforced tiles.

22. A method of making a reinforced tile, the method comprising:
providing a material for forming a tile,
applying heat to the material to form the tile, and
prior to the tile cooling to an ambient temperature, positioning an elastic composite member including reinforcing fibers thereon,
wherein the tile has a thickness of 10 millimeters or less, and
wherein heat from the cooling tile bonds the elastic composite member to the tile.

23. The method of claim 22, wherein the material is one of ceramic and porcelain.

24. The method of claim 22, wherein the elastic composite member has a flex shear strength of between 50 MPa and 90 MPa.

25. The method of claim 22, wherein the elastic composite member has a modulus of elasticity of between 2 GPa and 50 GPa.
